(19) United States
(12) Patent Application Publication
(10) Pub. No.: US 2014/0249068 A1
(43) Pub. Date: Sep. 4, 2014

(54) Concentrated Alkyl Ether Sulfate Amine Salt Compositions

(71) Applicant: Stepan Company, Northfield, IL (US)

(72) Inventors: Dennis S. Murphy, Libertyville, IL (US); Christopher A. Gariepy, Northbrook, IL (US)

(73) Assignee: Stepan Company, Northfield, IL (US)

(21) Appl. No.: 14/274,183

(22) Filed: May 9, 2014

Related U.S. Application Data
(63) Continuation of application No. PCT/US2012/064960, filed on Nov. 14, 2012.
(60) Provisional application No. 61/560,142, filed on Nov. 15, 2011.

(51) Int. Cl. C11D 3/34

(52) U.S. Cl. CPC C11D 3/3463
USPC 510/337; 510/346

(57) ABSTRACT

Phase stable, concentrated liquid detergent compositions containing from 21% to 74% by weight of at least one alkyl ether sulfate amine salt anionic surfactant are disclosed. The concentrated liquid detergent compositions also include from 2% to 50% by weight nonionic surfactants and contain less than 50% by weight water. A concentrated surfactant composition containing from 70% to 99% of one or more alkyl ether sulfate amine salts and from 1% to 30% water is also disclosed for use in formulating the concentrated liquid detergent compositions.

### RELATED APPLICATIONS

This application claims priority to, and is a continuation of, International application No. PCT/US2012/064960 (International Publication No. WO 2013/074589) having an International filing date of Nov. 14, 2012. This PCT application claims priority to and claims benefit from U.S. provisional Application No. 61/560,142, having a filing date of Nov. 15, 2011. The entire specifications of the PCT and provisional applications referred to above are hereby incorporated by reference.

### FIELD OF THE INVENTION

The present invention relates to concentrated liquid alkyl ether sulfate (AES) amine salt compositions directed to laundry cleaning applications.

### BACKGROUND OF THE INVENTION

In recent years there has been a trend to more concentrated liquid laundry detergent formulations. A challenge with these more concentrated systems is that anionic surfactants become increasingly difficult to keep from precipitating out of formulated systems. In turn, by virtue of the limitations on how much anionic surfactant can be incorporated, cleaning is compromised. It is also desirable to have surfactant concentrates which have minimal water or other solvent since transportation costs increase and for very concentrated detergent formulations, if there is too much water coming in with the surfactant, it may introduce more water to the formulation than the target amount would be. This may especially be true for formulations intended to be included in polyvinyl alcohol (PVA) pouches where the water content should be less than about 10% water. Indeed, if the surfactant brings in too much water, to keep the total water under 10% in a pouch formula may necessitate driving excess water off with heat which would take time, energy and may degrade ingredients in the formula.

In U.S. Pat. No. 8,026,203, a surfactant concentrate is taught which can be at least about 75% of an amine AES salt and 5% to 25% of a carboxylic acid. A drawback of the inclusion of the carboxylic acid is that it either needs to be neutralized in the formulation or if it is not neutralized in the formulation it will drop the pH in the wash water and higher pH values lead to better cleaning. Another drawback of the presence of the carboxylic acid is that it adds complexity in preparing and shipping the amine AES salt. The utilization of the amine AES salt in Examples A-F in this patent is limited to a maximum weight percent inclusion of 16.4% (Example B).

EP507402 describes compositions which can be high in anionic surfactant. However, no mention is made of neutralizing the acid from the anionic surfactant with amines. Indeed, only the sodium and potassium salts are mentioned. Further, nonionic surfactant must be present and in the examples the lowest amount of nonionic surfactant utilized is 28.4%. EP507402 teaches away from the use of little to no nonionic surfactant as compositions higher in anionic to nonionic ratio were found to be more viscous and less preferred.

WO01/79412, EP1272605 also teach high anionic-containing compositions. Although mention is made of the use of organic neutralizing agents, no mention is made of the specific sub-class of amines. In fact, it is stated that the sodium salts are preferred. WO 01/79412, EP1272605 also is directed to utilization in powdered detergents as evidenced by the preferred employment of structurants.

In U.S. Pat. No. 8,034,757, although amine AES salts are mentioned, none of them are used in the examples (sodium AES, prepared from Kalcol 4098, is used) and the highest concentration of AES in any of the inventive liquid formulations shown is 8%. Comparative example 2-12 does use 31% sodium AES, however that is total amount of surfactant present and the water content is quite high (greater than 50%) so this formulation would not be considered a concentrate.

In WO patent application No. 2011/031712, use of Monoethanolamine (MEA) AES salt is taught in liquid formulations. However, their maximum inclusion level in the examples provided is 9%.

In U.S. patent publication No. 2011/0209291, although it is stated that the amine salts of the anionic surfactants are preferred, it is unclear in the examples provided what type of AES salt has been utilized. Nonetheless, the maximum amount of AES used in any of the examples is 20.3%.

### SUMMARY OF THE INVENTION

It has surprisingly been found that liquid laundry detergent formulations containing high levels of anionic surfactant can be made to be stable to precipitation. It has also been surprisingly found that a concentrated anionic surfactant system can be composed which is low enough in viscosity to be able to be pumpable.

In a first aspect, the present technology provides a liquid laundry detergent composition comprising:

a. from 21% to 74% total of one or more alkyl ether sulfate amine salts;

b. from 2% to 50% of one or more nonionic surfactants;

c. less than 50% water;

wherein the total surfactant present is at least 45%.

In a second aspect, the present technology provides a concentrated surfactant composition comprising:

a. from 70% to 99% of one or more alkyl ether sulfate amine salts;

b. from 1% to 30% water;

wherein,

the viscosity of the composition at a shear rate of 10/s is less than 25,000 cP at 40° C.; and the composition contains less than 4% carboxylic acid either in its free acid form, a neutralized form, or combinations thereof.

### DETAILED DESCRIPTION OF THE INVENTION

### Definitions

“Concentrated” is defined herein as less than 50% by weight water.

“Pumpable” is defined as a surfactant concentrate which exhibits a viscosity at 10/s of less than 25,000 cP at 40° C.

“Structurant” is defined as an added component intended to achieve solidification in a mixer containing a particulate detergent.

### Liquid Detergent Composition

The liquid detergent compositions of the present technology are concentrated detergent compositions comprising a total surfactant amount of at least 45% by weight of the composition, alternatively at least 50% by weight of the composition.

It has been surprisingly found that such concentrated detergent compositions are stable and not susceptible to precipitation when the surfactant system used in the present detergent compositions comprises from 21% to about 74% by weight, alternatively from about 27.5% to about 74% by weight, alternatively from about 35% to about 74% by weight of one or more alkyl ether sulfate amine salts. Other salt forms of the alkyl ether sulfate anionic surfactant, such as the alkali metal or ammonium salt forms, are not suitable for forming concentrated liquid detergent compositions because, at concentrations of 21% by weight or greater, such salt forms tend to form precipitates and are not phase stable. In addition to the alkyl ether sulfate amine salt anionic surfactant, the concentrated detergent compositions comprise from about 2% to about 50% by weight, alternatively about 10% to about 50% by weight, alternatively about 13% to about 50% by weight of one or more nonionic surfactants. The water content of the liquid detergent compositions is less than 50% by weight, alternatively less than 40% by weight, alternatively less than 30% by weight, alternatively less than 20% by weight, alternatively less than 10% by weight of the composition.

The liquid detergent compositions of the present technology have a viscosity of less than 5000 cP, alternatively less than 3500 cP, alternatively less than 2000 cP, as measured with a Brookfield viscometer with RVT spindle #4 at 50 rpm.

The pH of the liquid detergent compositions is desirably between 7 and 11, alternatively between 7 and 10.

### Concentrated Surfactant Composition

The alkyl ether sulfate amine salts used in preparing the present concentrated liquid detergent compositions are conveniently formulated into a concentrated surfactant composition which can then be used in formulating the liquid detergent compositions. The concentrated surfactant composition can also be used in formulating other types of cleaning compositions, however, a preferred use of the concentrated surfactant composition is in formulating liquid laundry detergent compositions.

The concentrated surfactant composition comprises from 70% to 99% by weight of one or more alkyl ether sulfate amine salts, and from 1% to 30% by weight water. The concentrated surfactant composition contains less than 15% nonionic surfactant, alternatively less than 7.5% nonionic surfactant and preferably contains no nonionic surfactant. The concentrated surfactant composition also contains less than 4% by weight carboxylic acid, either in its free acid form, a neutralized form, or combinations thereof. Optionally, a structurant can be included in the concentrated surfactant composition, but preferably no structurant is included.

In a preferred embodiment, the alkyl ether sulfate amine salt plus the water together comprise at least 85% of the composition, preferably greater than 90% of the composition. The alkyl ether sulfate amine salt plus the water can also total 100% of the concentrated surfactant composition.

The concentrated anionic surfactant composition has a viscosity of less than 25,000 cP at a shear rate of 10/s at 40° C., preferably less than 15,000 cP, more preferably less than 10,000 cP at a shear rate of 10/s at 40° C. Since the upper limit of viscosity that conventional positive displacement pumps can handle is about 25,000 cP at a shear rate of 10/s, it can be appreciated that the present concentrated surfactant compositions are pumpable in such conventional equipment. Moreover, the concentrated surfactant compositions exhibit shear thinning behavior which helps in moving the concentrated compositions through a displacement pump, since localized shear rates in the displacement pump can exceed 10/s.

### Alkyl Ether Sulfate Amine Salts

The alkyl ether sulfate amine salts used in the detergent composition covered by the present technology are represented by the following structure:

R—(OC₂H₄)ₘ(OC₃H₆)ₙ—O—SO₃A

where R is a branched or straight chain, saturated or containing unsaturation, hydrocarbon having 6 to 22 carbon atoms, m represents an integer from 0 to 10, n represents an integer from 0 to 10, with the proviso that m+n cannot equal zero, and A is the protonated amine counterion. The alkyl ether sulfate amine salts will generally be used in the form of mixtures containing varying amounts of ethoxylation and propoxylation. Preferred alkyl ether sulfate amine salts for use herein are those containing an average value of 2 to 5, more preferably an average value of about 2.7 to about 3.3 moles of ethoxylation and no propoxylation. The amine used to neutralize the alkyl ether acid includes, but is not limited to: monoethanolamine, triethanolamine (TEA), monoisopropanolamine, and diisopropanolamine. Monoethanolamine is a preferred amine.

The R group may have a mixture of chain lengths and preferably contains a predominant portion of 12-16 carbon atoms. It is preferred that the acid form of anionic surfactant be neutralized with the amine to greater than 80% in a first step, more preferably to 100% in a single step and most preferably to 100% in a single step using a loop neutralizer.

### Other Anionic Surfactants

Although it is preferred that the alkyl ether sulfate amine salt be the only anionic surfactant used in the compositions, other anionic surfactants can be added.

“Anionic surfactants” are defined here as amphiphilic molecules with an average molecular weight of less than about 10,000, comprising one or more functional groups that exhibit a net anionic charge when in aqueous solution at a pH between 6 and 11. The anionic surfactant used in the present technology can be any anionic surfactant that is substantially water soluble. “Water soluble” surfactants are, unless otherwise noted, here defined to include surfactants which are soluble or dispersible to at least the extent of 0.01% by weight in distilled water at 25° C.

Specific types of anionic surfactants are identified in the following paragraphs.

Carboxylic acid salts are represented by the formula:

R¹COOM

where R¹ is a primary or secondary alkyl group of 4 to 30 carbon atoms and M is a solubilizing cation. The alkyl group represented by R¹ may represent a mixture of chain lengths and may be saturated or unsaturated, although it is preferred that at least two thirds of the R¹ groups have a chain length of between 8 and 18 carbon atoms. Non-limiting examples of suitable alkyl group sources include the fatty acids derived from coconut oil, tallow, tall oil and palm kernel oil. For the purposes of minimizing odor, however, it is often desirable to use primarily saturated carboxylic acids. Such materials are well known to those skilled in the art, and are available from many commercial sources, such as Uniqema (Wilmington, Del.) and Twin Rivers Technologies (Quincy, Mass.). The solubilizing cation, M, may be any cation that confers water solubility to the product, although monovalent moieties are generally preferred. Examples of acceptable solubilizing cations for use with the present technology include alkali metals such as sodium and potassium, and amines such as triethanolammonium, ammonium and morpholinium. Although when used, the majority of the fatty acid should be incorporated into the formulation in neutralized salt form, a small amount of free fatty acid can be included in the formulation, as this can aid in the maintenance of product viscosity.

Primary alkyl sulfates are represented by the formula:

R²OSO₃M

where R² is a primary alkyl group of 8 to 18 carbon atoms. M is H or a cation, e.g., an alkali metal cation (e.g. sodium, potassium, lithium), or ammonium or substituted ammonium (e.g. methyl-, dimethyl-, and trimethyl ammonium cations and quaternary ammonium cations such as tetramethyl-ammonium and dimethyl piperidinium cations and quaternary ammonium cations derived from alkylamines such as ethylamine, diethylamine, triethylamine, and mixtures thereof, and the like). The alkyl group R² may have a mixture of chain lengths. It is preferred that at least two-thirds of the R² alkyl groups have a chain length of 8 to 14 carbon atoms. This will be the case if R² is coconut alkyl, for example. The solubilizing cation may be a range of cations which are in general monovalent and confer water solubility, such as, for example alkali metal cations. Other possibilities are ammonium and substituted ammonium ions, such as trialkanolammonium or trialkylammonium.

Other suitable anionic surfactants that can be used are alkyl ester sulfonate surfactants including linear esters of C₈-C₂₀ carboxylic acids (i.e., fatty acids) which are sulfonated with gaseous SO₃ according to “The Journal of the American Oil Chemists Society”, 52 (1975), pp. 323-329. Suitable starting materials would include natural fatty substances as derived from tallow, palm oil, etc.

The preferred alkyl ester sulfonate surfactants, especially for laundry applications, comprise alkyl ester sulfonate surfactants of the structural formula:

R³—CH(SO₃M)-C(O)—OR⁴

where R³ is a C₈-C₂₀ hydrocarbyl, preferably an alkyl or combination thereof R⁴ is a C₁-C₆ hydrocarbyl, preferably an alkyl, or combination thereof, and M is a cation which forms a water soluble salt with the alkyl ester sulfonate. Suitable salt-forming cations include metals such as sodium, potassium, and lithium, and substituted or unsubstituted ammonium cations, such as monoethanolamine, diethanolamine, and triethanolamine. Preferably, R³ is C₁₀-C₁₆ alkyl, and R⁴ is methyl, ethyl or isopropyl. Especially preferred are the methyl ester sulfonates where R³ is C₁₀-C₁₆ alkyl.

Fatty acid ester sulfonates are represented by the formula:

R⁴CH(SO₃M)CO₂R⁵

where R⁴ is an alkyl group of 6 to 16 atoms, R⁵ is an alkyl group of 1 to 4 carbon atoms and M is a solubilizing cation. The group R⁴ may have a mixture of chain lengths. Preferably at least two-thirds of these groups have 6 to 12 carbon atoms. This will be the case when the moiety R⁴CH(−)CO₂(−) is derived from a coconut source, for instance. It is preferred that R⁵ is a straight chain alkyl, notably methyl or ethyl.

Alkyl benzene sulfonates are represented by the formula:

R⁶ArSO₃M

where R⁶ is an alkyl group of 8 to 18 carbon atoms, Ar is a benzene ring (—C₆H₄—) and M is a solubilizing cation. The group R⁶ may be a mixture of chain lengths. A mixture of isomers is typically used, and a number of different grades, such as “high 2-phenyl” and “low 2-phenyl” are commercially available for use depending on formulation needs. A plentitude of commercial suppliers exist for these materials, including Stepan (Northfield, Ill.) and Witco (Greenwich, Conn.). Typically they are produced by the sulfonation of alkylbenzenes, which can be produced by either the HF-catalyzed alkylation of benzene with olefins or an AlCl₃-catalyzed process that alkylates benzene with chloroparaffins, and are sold by, for example, Petresa (Chicago, Ill.) and Sasol (Austin, Tex.). Straight chains of 11 to 14 carbon atoms are usually preferred.

Paraffin sulfonates having about 8 to about 22 carbon atoms, preferably about 12 to about 16 carbon atoms, in the alkyl moiety, are contemplated for use here. They are usually produced by the sulfoxidation of petrochemically-derived normal paraffins. These surfactants are commercially available as, for example, Hostapur SAS from Clariant (Charlotte, N.C.).

Olefin sulfonates having 8 to 22 carbon atoms, preferably 12 to 16 carbon atoms, are also contemplated for use in the present compositions. The olefin sulfonates are further characterized as having from 0 to 1 ethylenic double bonds; from 1 to 2 sulfonate moieties, of which one is a terminal group and the other is not; and 0 to 1 secondary hydroxyl moieties. U.S. Pat. No. 3,332,880 contains a description of suitable olefin sulfonates, and is incorporated here by reference.

Sulfosuccinate esters represented by the formula:

R⁷OOCCH₂CH(SO₃⁻M⁺)COOR⁸

are also useful in the context of the present technology. R⁷ and R⁸ are alkyl groups with chain lengths of between 2 and 16 carbons, and may be linear or branched, saturated or unsaturated. A preferred sulfosuccinate is sodium bis(2-ethylhexyl)sulfosuccinate, which is commercially available under the trade name Aerosol OT from Cytec Industries (West Paterson, N.J.).

Organic phosphate based anionic surfactants include organic phosphate esters such as complex mono- or diester phosphates of hydroxyl-terminated alkoxide condensates, or salts thereof. Included in the organic phosphate esters are phosphate ester derivatives of polyoxyalkylated alkylaryl phosphate esters, of ethoxylated linear alcohols and ethoxylates of phenol. Also included are nonionic alkoxylates having a sodium alkylenecarboxylate moiety linked to a terminal hydroxyl group of the nonionic through an ether bond. Counterions to the salts of all the foregoing may be those of alkali metal, alkaline earth metal, ammonium, alkanolammonium and alkylammonium types.

Other anionic surfactants useful for detersive purposes can also be included in the detergent compositions of the present technology. These can include salts (including, for example, sodium, potassium, ammonium, and substituted ammonium salts such as mono-, di- and triethanolamine salts) of soap, C₈-C₂₂ primary or secondary alkanesulfonates, C₈-C₂₄ olefin sulfonates, sulfonated polycarboxylic acids prepared by sulfonation of the pyrolyzed product of alkaline earth metal citrates, e.g., as described in British patent specification No. 1,082,179, C₈-C₂₄ alkypolyglycolethersulfates (containing up to 10 moles of ethylene oxide); alkyl glycerol sulfonates, fatty acyl glycerol sulfonates, fatty oleoyl glycerol sulfates, alkyl phenol ethylene oxide ether sulfates, paraffin sulfonates, alkyl phosphates, isethionates such as the acyl isethionates, N-acyl taurates, alkyl succinamates and sulfosuccinates, monoesters of sulfosuccinates (especially saturated and unsaturated C₁₂-C₁₈ monoesters) and diesters of sulfosuccinates (especially saturated and unsaturated C₆-C₁₂ diesters), sulfates of alkylpolysaccharides such as the sulfates of alkylpolyglucoside (the nonionic non-sulfated compounds being described below), and alkyl polyethoxy carboxylates such as those of the formula RO(CH₂CH₂O)ₖCH₂COO-M+ where R is a C₈-C₂₂ alkyl, k is an integer from 0 to 10, and M is a soluble salt-forming cation. Resin acids and hydrogenated resin acids are also suitable, such as rosin, hydrogenated rosin, and resin acids and hydrogenated resin acids present in or derived from tall oil. Further examples are described in “Surface Active Agents and Detergents” (Vol. I and II by Schwartz, Perry and Berch). A variety of such surfactants are also generally disclosed in U.S. Pat. No. 3,929,678, issued Dec. 30, 1975 to Laughlin, et al. at Column 23, line 58 through Column 29, line 23 (incorporated here by reference), and Unilever U.S. Pat. No. 6,949,498 column 6, line 4 through column 8, line 30 (incorporated here by reference), from which much of the present discussion comes.

Other anionic surfactants contemplated for use with this formulation include isethionates, sulfated triglycerides, alcohol sulfates, ligninsulfonates, naphthelene sulfonates and alkyl naphthelene sulfonates and the like. Additional anionic surfactants, falling into the general definition but not specifically mentioned above, should also be considered within the scope of the present technology.

### Nonionic Surfactants

Suitable nonionic surfactants for use in the present liquid detergent compositions include alkyl polyglucosides (“APGs”), alcohol ethoxylates, nonylphenol ethoxylates, and others. Other suitable nonionic surfactants are described in P&G U.S. Pat. No. 5,929,022; column 4, 2nd paragraph through column 6, end of 1st paragraph, from which much of the following discussion comes:

One class of nonionic surfactants useful in the practice of the present technology are condensates of ethylene oxide with a hydrophobic moiety to provide a surfactant having an average hydrophilic-lipophilic balance (HLB) in the range from 8 to 17, preferably from 9.5 to 14, more preferably from 12 to 14. The hydrophobic (lipophilic) moiety may be aliphatic or aromatic in nature and the length of the polyoxyethylene group which is condensed with any particular hydrophobic group can be readily adjusted to yield a water-soluble compound having the desired degree of balance between hydrophilic and hydrophobic elements.

Especially preferred nonionic surfactants of this type are the C₉-C₁₅ primary alcohol ethoxylates containing 3-12 moles of ethylene oxide per mole of alcohol, particularly the C₁₂-C₁₅ primary alcohols containing 5-8 moles of ethylene oxide per mole of alcohol. One suitable example of such a surfactant is polyalkoxylated aliphatic base, sold for example as Makon® NF-12 by Stepan Co.

Another class of nonionic surfactants comprises alkyl polyglucoside compounds of general formula:

RO—(CₙH₂ₙO)ₜZₓ

where Z is a moiety derived from glucose; R is a saturated hydrophobic alkyl group that contains from 12 to 18 carbon atoms; t is from 0 to 10 and n is 2 or 3; x is an average value from 1.3 to 4, the compounds including less than 10% unreacted fatty alcohol and less than 50% short chain alkyl polyglucosides. Compounds of this type and their use in detergent compositions are disclosed in EP-B 0 070 077, EP 0 075 996 and EP 0 094 118.

Other suitable nonionic surfactants are poly hydroxy fatty acid amide surfactants of the formula:

R²—C(O)—N(R¹)—Z

where R¹ is H, or R¹ is C₁₋₄ hydrocarbyl, 2-hydroxyethyl, 2-hydroxypropyl or a mixture thereof, R² is C₅₋₃₁ hydrocarbyl, and Z is a polyhydroxy hydrocarbyl having a linear hydrocarbyl chain with at least 3 hydroxyls directly connected to the chain, or an alkoxylated derivative thereof. Preferably, R¹ is methyl, R² is a straight C₁₁₋₁₅ alkyl or alkenyl chain such as coconut alkyl or mixtures thereof, and Z is derived from a reducing sugar such as glucose, fructose, maltose, lactose, in a reductive amination reaction.

Other suitable nonionics are amine oxide surfactants. The compositions of the present technology may comprise amine oxide in accordance with the general formula:

R¹(EO)ₓ(PO)_{y}(BO)_{z}N(O)(CH₂R′)₂·H₂O

In general, it can be seen that the preceding formula provides one long-chain moiety R¹(EO)ₓ(PO)_{y}(BO)_{z} and two short chain moieties, —CH₂R′. R′ is preferably selected from hydrogen, methyl and —CH₂OH. In general R¹ is a primary or branched hydrocarbyl moiety which can be saturated or unsaturated, preferably, R¹ is a primary alkyl moiety. When x+y+z=0, R¹ is a hydrocarbyl moiety having a chain length of from about 8 to about 18. When x+y+z is different from 0, R¹ may be somewhat longer, having a chain length in the range C₁₂-C₂₄. The general formula also encompasses amine oxides where x+y+z=0, R¹ is C₈-C₁₈, R′ is H and q=from 0 to 2, preferably 2. These amine oxides are illustrated by C₁₂₋₁₄ alkyldimethyl amine oxide, hexadecyl dimethylamine oxide, octadcylamine oxide and their hydrates, especially the dihydrates as disclosed in U.S. Pat. Nos. 5,075,501 and 5,071,594, which are incorporated herein by reference.

The presently described technology also encompasses amine oxides where x+y+z is different from zero, specifically x+y+z is from about 1 to about 10, and R¹ is a primary alkyl group containing about 8 to about 24 carbons, preferably from about 12 to about 16 carbon atoms. In these embodiments y+z is preferably 0 and x is preferably from about 1 to about 6, more preferably from about 2 to about 4; EO represents ethyleneoxy; PO represents propyleneoxy; and BO represents butyleneoxy. Such amine oxides can be prepared by conventional synthetic methods, e.g., by the reaction of alkylethoxysulfates with dimethylamine followed by oxidation of the ethoxylated amine with hydrogen peroxide.

In addition to the anionic and nonionic surfactants, it is contemplated that the liquid detergent compositions can contain additional surfactants, for example cationic surfactants, ampholytic surfactants and zwitterionic surfactants.

### Cationic Surfactants

Specific cationic surfactants contemplated for use in the present compositions include ditallow dimethylammonium chloride (DTDMAC), fatty alkanolamides (FAA), and quaternized diesters of trialkanolamines and fatty acids. The proportions of cationic surfactants used in a formulation can range, for example, from 0.1% to 20%, more preferably between 1% and 10%, even more preferably between 1% and 5%. See also P&G U.S. Pat. No. 5,929,022; column 6, 2nd paragraph through column 7, 1st paragraph, from which much of the following discussion comes:

Cationic detersive surfactants suitable for use in the compositions of the present technology include those having one long-chain hydrocarbyl group. Examples of such cationic surfactants include the ammonium surfactants such as alkyldimethylammonium halogenides, and those surfactants having the formula:

[R²(OR³)_{y}][R⁴(OR³)_{y}]₂R⁵N⁺X⁻

where R² is an alkyl or alkyl benzyl group having from about 8 to about 18 carbon atoms in the alkyl chain, each R³ is selected from the group consisting of —CH₂CH₂—, —CH₂CH(CH₃)—, —CH₂CH(CH₂OH)—, —CH₂CH₂CH₂—, and mixtures thereof; each R⁴ is selected from the group consisting of C₁-C₄ alkyl, C₁-C₄ hydroxyalkyl, benzyl ring structures formed by joining the two R⁴ groups, —CH₂CHOH—CH(OH)C(O)R⁶CH(OH)CH₂OH where R⁶ is any hexose or hexose polymer having a molecular weight less than about 1000, and hydrogen when y is not 0; R⁵ is the same as R⁴ or is an alkyl chain where the total number of carbon atoms of R² plus R⁵ is not more than about 18; each y is from 0 to about 10 and the sum of the y values is from 0 to about 15; and X is any compatible anion. The long chain cationic surfactant can also be the quaternized version of stearamidopropyl dimethylamine (e.g. stearamidopropyl trimethylamine chloride).

Preferred cationic surfactants are the water-soluble quaternary ammonium compounds having the formula:

R¹R²R³R⁴N⁺X⁻

where R¹ is C₈-C₁₆ alkyl, each of R², R³ and R⁴ is independently C₁-C₄ alkyl, C₁-C₄ hydroxyalkyl, benzyl, or —(C₂H₄O)ₓ H where x has a value from 1 to 5, and X is an anion. In an embodiment, not more than one of R², R³ or R⁴ is benzyl.

The preferred alkyl chain length for R¹ is C₁₂-C₁₅, particularly where the alkyl group is a mixture of chain lengths derived from coconut or palm kernel fat or is derived synthetically by olefin build up or OXO alcohols synthesis. Preferred groups for R², R³, and R⁴ are methyl and hydroxyethyl groups and the anion X may be selected from halide, methosulphate, acetate and phosphate ions.

Examples of suitable quaternary ammonium compounds for use here are:

hexadecyl trimethyl ammonium chloride, also known as cetrimonium chloride, sold commercially as Ammonyx® CETAC by Stepan Co.;

coconut trimethyl ammonium chloride or bromide;

coconut methyl dihydroxyethyl ammonium chloride or bromide;

decyl triethyl ammonium chloride;

decyl dimethyl hydroxyethyl ammonium chloride or bromide;

C₁₂₋₁₅ dimethyl hydroxyethyl ammonium chloride or bromide;

coconut dimethyl hydroxyethyl ammonium chloride or bromide;

myristyl trimethyl ammonium methyl sulphate;

lauryl dimethyl benzyl ammonium chloride or bromide;

lauryl dimethyl (ethenoxy)4 ammonium chloride or bromide;

choline esters of formula:

R¹R²R³R⁴N⁺X⁻

where R¹ is —CH₂—O—C(O)—(C₁₂₋₁₄ alkyl) and R², R³, and R⁴ are methyl; and combinations of these.

Other cationic surfactants useful here are also described in U.S. Pat. No. 4,228,044, Cambre, issued Oct. 14, 1980, incorporated herein by reference. Cationic surfactants, if present, can be used at a level of from 0% to 10%, more preferably from 0.1% to 5% by weight of the present formulations.

### Ampholytic Surfactants

Ampholytic synthetic detergents can be broadly described as derivatives of aliphatic or aliphatic derivatives of heterocyclic secondary and tertiary amines, in which the aliphatic radical may be straight chain or branched and where one of the aliphatic substituents contains from about 8 to about 18 carbon atoms and at least one contains an anionic water-solubilizing group, e.g., carboxy, sulfo, sulfato, phosphato, or phosphono (see U.S. Pat. No. 3,664,961, which provides specific examples of ampholytic surfactants from col. 6, line 60, to col. 7, line 53, incorporated here by reference). Examples of suitable ampholytic surfactants include fatty amine oxides and fatty amidopropylamine oxides. A specific suitable example is cocoamidopropyl betaine (CAPB) also known as coco betaine. Ampholytic surfactants, if present, can be used at a level from 0% to 10%, more preferably from 0.1% to 5% by weight of the formulation.

### Zwitterionic Surfactants

Zwitterionic synthetic detergents can be broadly described as derivatives of aliphatic quaternary ammonium and phosphonium or tertiary sulfonium compounds, in which the cationic atom may be part of a heterocyclic ring, and in which the aliphatic radical may be straight chain or branched, and where one of the aliphatic substituents contains from about 3 to 18 carbon atoms, and at least one aliphatic substituent contains an anionic water-solubilizing group, e.g., carboxy, sulfo, sulfato, phosphato, or phosphono. (see U.S. Pat. No. 3,664,961, which provides specific examples of zwitterionic surfactants from col. 7, line 65, to col. 8, line 75, incorporated here by reference). Zwitterionic surfactants, if present, can be used at a level from 0% to 10%, more preferably from 0.1% to 5% by weight of the present formulations.

### Mixtures of Surfactants

Mixtures of any two or more individually contemplated surfactants, whether of the same type or different types, are contemplated herein.

### Builders and Alkaline Agents

Builders and other alkaline agents are contemplated for use in the present formulations.

Any conventional builder system is suitable for use here, including aluminosilicate materials, silicates, polycarboxylates and fatty acids, materials such as ethylenediamine tetraacetate, metal ion sequestrants such as aminopolyphosphonates, particularly ethylenediamine tetramethylene phosphonic acid and diethylene triamine pentamethylenephosphonic acid. Though less preferred for obvious environmental reasons, phosphate builders could also be used here.

Suitable polycarboxylate builders for use here include citric acid, preferably in the form of a water-soluble salt, and derivatives of succinic acid of the formula:

R—CH(COOH)CH₂(COOH)

where R is C₁₀₋₂₀ alkyl or alkenyl, preferably C₁₂₋₁₆, or where R can be substituted with hydroxyl, sulfo sulfoxyl or sulfone substituents. Specific examples include lauryl succinate, myristyl succinate, palmityl succinate 2-dodecenylsuccinate, or 2-tetradecenyl succinate. Succinate builders are preferably used in the form of their water-soluble salts, including sodium, potassium, ammonium and alkanolammonium salts.

Other suitable polycarboxylates are oxodisuccinates and mixtures of tartrate monosuccinic and tartrate disuccinic acid, as described in U.S. Pat. No. 4,663,071.

Especially for a liquid detergent composition, suitable fatty acid builders for use here are saturated or unsaturated C₁₀₋₁₈ fatty acids, as well as the corresponding soaps. Preferred saturated species have from 12 to 16 carbon atoms in the alkyl chain. The preferred unsaturated fatty acid is oleic acid. Another preferred builder system for liquid compositions is based on dodecenyl succinic acid and citric acid.

Some examples of alkaline agents include alkalic metal hydroxides, carbonates, bicarbonates. Another commonly used builder is borax.

For liquid compositions, the builder or alkaline agent typically comprises from 1% to 15% by weight of the formulation. See U.S. Pat. No. 5,929,022; column 7, start of 2nd paragraph through column 7, end of 6th paragraph, from which much of the preceding discussion comes. Other builders are described in PCT Publ. WO 99/05242, which is incorporated here by reference.

### Enzymes

The detergent compositions of the present technology may further comprise one or more enzymes, which provide cleaning performance and/or fabric, care benefits. Suitable enzymes include enzymes selected from cellulases, hemicellulases, peroxidases, proteases, gluco-amylases, amylases, lipases, cutinases, pectinases, xylanases, reductases, oxidases, phenoloxidases, lipoxygenases, ligninases, pullulanases, tannases, pentosanases, malanases, beta-glucanases, arabinosidases or mixtures thereof.

A preferred combination is a detergent composition having a cocktail of conventional applicable enzymes like protease, amylase, lipase, cutinase and/or cellulase in conjunction with the lipolytic enzyme variant D96L at a level of from 50 LU to 8500 LU per liter wash solution.

The cellulases usable in the present technology include both bacterial or fungal cellulase. Preferably, they will have a pH optimum of between 5 and 9.5. Suitable cellulases are disclosed in U.S. Pat. No. 4,435,307, Barbesgoard et al, which discloses fungal cellulase produced from Humicola insolens. Suitable cellulases are also disclosed in GB-A-2 075 028; GB-A-2 095 275 and DE-OS-2 247 832, which are incorporated herein by reference.

Examples of such cellulases are cellulases produced by a strain of Humicola insolens (Humicola grisea var. thermoidea), particularly the Humicola strain DSM 1800. Other suitable cellulases are cellulases originated from Humicola insolens having a molecular weight of about 50 KDa, an isoelectric point of 5.5 and containing 415 amino acids. Especially suitable cellulases are the cellulases having color care benefits. Examples of such cellulases are cellulases described in European patent application No. 91202879.2, filed Nov. 6, 1991 (Novo).

Peroxidase enzymes are used in combination with oxygen sources, e.g. percarbonate, perborate, persulfate, hydrogen peroxide, etc. They are used for “solution bleaching”, i.e. to prevent transfer of dyes or pigments removed from substrates during wash operations to other substrates in the wash solution. Peroxidase enzymes are known in the art, and include, for example, horseradish peroxidase, ligninase, and haloperoxidase such as chloro- and bromo-peroxidase. Peroxidase-containing detergent compositions are disclosed, for example, in PCT International Application WO 89/099813 and in European Patent application EP No. 91202882.6, filed on Nov. 6, 1991.

Suitable cellulases and/or peroxidases are normally incorporated in the detergent composition at levels from 0.0001% to 2% of active enzyme by weight of the detergent composition.

Preferred commercially available protease enzymes include those sold under the tradenames Alcalase®, Savinase®, Primase®, Durazym®, and Esperase® by Novo Nordisk A/S (Denmark), those sold under the tradename Maxatase®, Maxacal® and Maxapem® by Gist-Brocades, those sold by Genencor International, and those sold under the tradename Opticlean® and Optimase® by Solvay Enzymes. Other proteases are described in U.S. Pat. No. 5,679,630, issued Oct. 21, 1997 (P&G) can be included in the detergent composition of the present technology. Protease enzyme may be incorporated into the compositions in accordance with the present technology at a level of from about 0.0001% to about 2% active enzyme by weight of the composition.

Highly preferred enzymes that can be included in the detergent compositions of the present technology include lipases. Suitable lipase enzymes include those produced by microorganisms of the Pseudomonas group, such as Pseudomonas stutzeri ATCC 19.154, as disclosed in British Patent 1,372,034. Suitable lipases include those which show a positive immunological cross-reaction with the antibody of the lipase, produced by the microorganism Pseudomonas fluorescens IAM 1057. This lipase is available from Amano Pharmaceutical Co. Ltd., Nagoya, Japan, under the trade name Lipase P “Amano,” hereafter referred to as “Amano-P”. Further suitable lipases are lipases such as M1 Lipase®. and Lipomax®. (Gist-Brocades).

Also suitable are cutinases [EC 3.1.1.50] which can be considered as a special kind of lipase, namely lipases which do not require interfacial activation. Addition of cutinases to detergent compositions have been described in e.g. WO-A-88/09367 (Genencor).

The lipases and/or cutinases are normally incorporated in the detergent composition at levels from 0.0001% to 2% of active enzyme by weight of the detergent composition.

Amylases (α and/or β) can be included for removal of carbohydrate-based stains. Suitable amylases are Termamyl® (Novo Nordisk), Fungamyl® and BAN® (Novo Nordisk).

The above-mentioned enzymes may be of any suitable origin, such as vegetable, animal, bacterial, fungal and/or yeast origin. See U.S. Pat. No. 5,929,022; column 7, 7th paragraph through column 9, 6th paragraph, from which much of the preceding discussion comes. Preferred compositions optionally contain a combination of enzymes or a single enzyme, with the amount of each enzyme commonly ranging from 0.0001% to 2%.

### Adjuvants

The liquid detergent compositions of the present technology optionally contain one or more soil suspending agents or resoiling inhibitors in an amount from about 0.01% to about 5% by weight, alternatively less than about 2% by weight. Resoiling inhibitors include anti-redeposition agents, soil release agents, or combinations thereof. Examples of suitable agents are described in U.S. Pat. No. 5,929,022; column 10, 3rd paragraph through column 10, 5th paragraph, and include water-soluble ethoxylated amines having clay soil removal and anti-redeposition properties. Examples of such soil release and anti-redeposition agents given in the referenced patent include an ethoxylated tetraethylenepentamine. The ethoxylated amines further described in U.S. Pat. No. 4,597,898, VanderMeer, issued Jul. 1, 1986, are incorporated here by reference. Another group of preferred clay soil removal/anti-redeposition agents are the cationic compounds disclosed in European Patent Application 111,965, Oh and Gosselink, published Jun. 27, 1984, incorporated here by reference. Other clay soil removal/anti-redeposition agents which can be used include the ethoxylated amine polymers disclosed in European Patent Application 111,984, Gosselink published Jun. 27, 1984; the zwitterionic polymers disclosed in European Patent Application 112,592, Gosselink, published Jul. 4, 1984; and the amine oxides disclosed in U.S. Pat. No. 4,548,744, Connor, issued Oct. 22, 1985, all of which are incorporated here by reference.

Other clay soil removal and/or anti-redeposition agents known in the art can also be utilized in the compositions hereof. Another type of preferred anti-redeposition agent includes the carboxymethylcellulose (CMC) materials.

For example, optionally, anti-redeposition polymers can be incorporated into the present compositions. In at least some embodiments, it is preferred to keep the level of anti-redeposition polymer below about 2%. At levels above about 2%, anti-redeposition polymer may cause formulation instability (e.g. phase separation) and or undue thickening.

Soil release agents are also contemplated as optional ingredients in the amount of about 0.1% to about 5%. See U.S. Pat. No. 5,929,022; column 9, 8th paragraph through column 10, end of 1st partial paragraph.

Chelating agents in the amounts of about 0.1% to about 10%, more preferably about 0.5% to about 5% and even more preferably from about 0.8% to about 3% are also contemplated as an optional ingredient. See U.S. Pat. No. 5,929,022; column 10, 1st paragraph to column 10, end of 2nd paragraph.

Polymeric dispersing agents in the amount of 0% to about 6% are also contemplated as an optional component of the presently described compositions. See U.S. Pat. No. 5,929,022; column 10, start of 7th paragraph to column 10, end of the continuing paragraph from that started on the previous column and is incorporated herein by reference.

### Adjunct Ingredients

The liquid detergent compositions optionally include one or more laundry adjunct ingredients. The term “adjunct ingredient” includes: perfumes, dispersing agents, stabilizers, pH control agents, metal ion control agents, colorants, brighteners, dyes, odor control agent, pro-perfumes, cyclodextrin, perfume, solvents, soil release polymers, preservatives, antimicrobial agents, chlorine scavengers, anti-shrinkage agents, fabric crisping agents, spotting agents, anti-oxidants, anti-corrosion agents, bodying agents, drape and form control agents, smoothness agents, static control agents, wrinkle control agents, sanitization agents, disinfecting agents, germ control agents, mold control agents, mildew control agents, antiviral agents, antimicrobials, drying agents, stain resistance agents, soil release agents, malodor control agents, fabric refreshing agents, chlorine bleach odor control agents, dye fixatives, dye transfer inhibitors, color maintenance agents, color restoration, rejuvenation agents, anti-fading agents, whiteness enhancers, anti-abrasion agents, wear resistance agents, fabric integrity agents, anti-wear agents, and rinse aids, UV protection agents, sun fade inhibitors, insect repellents, anti-allergenic agents, enzymes, flame retardants, water proofing agents, fabric comfort agents, water conditioning agents, shrinkage resistance agents, stretch resistance agents, and combinations thereof. If present, such adjuncts can be used at a level of from 0.1% to 5% by weight of the composition.

### Unit Dose Packaging

In some embodiments of the present technology, the liquid detergent composition can be packaged within a water soluble film to form a unit dose packet or pouch. Suitable materials for the water soluble film include polyvinyl alcohol, partially hydrolyzed polyvinyl acetate and alginates. Films of polyvinyl alcohol are particularly suitable. The unit does packet can comprise a single or multi-compartment pouch where the liquid detergent composition can be used in conjunction with any other conventional powder or liquid laundry composition. Examples of suitable water-soluble films and packets are disclosed in U.S. Pat. No. 6,037,319.

### EXAMPLES

Viscosity measurements on the finished liquid compositions were taken on a Brookfield DV-II+ Pro Viscometer with an RVT spindle #4 at 50 rpm.

Viscosity measurements on the concentrated surfactant systems samples were taken on an Advanced Rheometer model number AR 2000 at a shear rate of 10/sec.

### Example 1

### Liquid Laundry Formulations Suitable for Inclusion in PVA Pouches Follow

| | Formulation | | |
|---|---|---|---|
| Ingredient/Property | 1 (prophetic) | 2 | 3 |
| MEA AES | 21 | 27.5 | 35 |
| BIO-SOFT ® N25-7 | 24 | 17.5 | 10 |
| Oleic Acid | 13 | 13 | 13 |
| Formic Acid | 1.1 | 1.1 | 1.1 |
| Glycerol | 21 | 21 | 21 |
| Propylene glycol | 5.5 | 5.5 | 5.5 |
| Monoethanolamine | 8 | 8 | 8 |
| Calcium Chloride | 0.02 | 0.02 | 0.02 |
| Anhydrous | | | |
| Protease | 1 | 1 | 1 |
| Amylase | 0.2 | 0.2 | 0.2 |
| Water | 5.2 | 5.2 | 5.2 |
| pH | 8.0 | 8.0 | 8.0 |
| Viscosity cP | — | 1180 | 1492 |

Formulations 1-3 are examples of compositions which fall within the scope of this invention. The water content of these formulations for inclusion in a PVA film may be a little low, but it would be easy to adjust the water content by removing some of the glycerol such that the water content is closer to 8% which is optimal for inclusion in a PVA pouch.

### Example 2

### The Following Six Prophetic Formulations Further Illustrate the Invention

| | Formulation | | |
|---|---|---|---|
| Ingredient | 4 | 5 | 6 |
| MEA AES* | 21-50 | 35 | 42 |
| Nonionic Surfactant | 2-40 | 25 | 22 |
| Borax Pentahydrate | 0-3 | 2.25 | 2 |
| Glycerol | 0-4 | | 4 |
| Propylene glycol | 0-4 | 2 | |
| Monoethanolamine | 0.5-3 | 1 | 3 |
| Triethanolamine | 0.5-3 | 1 | 3 |
| Citric Acid | 0.5-5 | 3 | 3 |
| Protease | 0.5-2 | 1 | 2 |
| Amylase | 0.1-1 | 0.2 | 0.5 |
| Water | 20-49 | To 100% | To 100% |

*Alkyl chain contains a predominant portion of 12-16 carbon atoms.

| | Formulation | | |
|---|---|---|---|
| Ingredient | 7 | 8 | 9 |
| TEA AES* | 21-50 | 35 | 42 |
| Nonionic Surfactant | 2-40 | 25 | 22 |
| Borax Pentahydrate | 0-3 | 2.25 | 2 |
| Glycerol | 0-4 | | 4 |
| Propylene glycol | 0-4 | 2 | |
| Monoethanolamine | 0.5-3 | 1 | 3 |
| Triethanolamine | 0.5-3 | 1 | 3 |
| Citric Acid | 0.5-5 | 3 | 3 |
| Protease | 0.5-2 | 1 | 2 |
| Amylase | 0.1-1 | 0.2 | 0.5 |
| Water | 20-49 | To 100% | To 100% |

*Alkyl chain contains a predominant portion of 12-16 carbon atoms.

### Example 3

| | Formulation 10 |
|---|---|
| Ingredient | Comparative and Prophetic |
| Na AES* | 21 |
| BIO-SOFT ® N25-7 | 24 |
| Oleic Acid | 13 |
| Formic Acid | 1.1 |
| Glycerol | 21 |
| Propylene glycol | 5.5 |
| Monoethanolamine | 8 |
| Calcium Chloride Anhydrous | 0.02 |
| Protease | 1 |
| Amylase | 0.2 |
| Water | 5.2 |

*Alkyl chain contains a predominant portion of 12-16 carbon atoms.

Formulation 10 is not within the scope of the present claims since it will form a precipitate based on the insolubility of the sodium AES in this concentrated formulation.

### Example 4

### Comparative

| Ingredient | Formulation 11 |
|---|---|
| Ammonium AES* | 20 |
| BIO-SOFT ® N25-7 | 25 |
| Oleic Acid | 13 |
| Formic Acid | 1.1 |
| Glycerol | 21 |
| Propylene glycol | 5.5 |
| Monoethanolamine | 8 |
| Calcium Chloride Anhydrous | 0.02 |
| Protease | 1 |
| Amylase | 0.2 |
| Water | 5.2 |

*Alkyl chain contains a predominant portion of 12-16 carbon atoms.

Due to the lower solubility of ammonium AES (versus amine AES), this formula separated into two phases and is not within the scope of the present claims. Higher inclusion levels of ammonium AES would make the separation even worse.

### Example 5

### The Following Surfactant Concentrates in Water were Made and their Viscosities Measured at 40° C.

| Surfactant Concentrate | Viscosity (cP) at 10/s | Viscosity (cP) at 32/s |
|---|---|---|
| 80% MEA AES | 5700 | 3177 |
| 85% MEA AES | 10736 | 4209 |
| 90% MEA AES | 13054 | 4370 |
| 94% MEA AES | 14500 | 5294 |

All of these concentrates are within the scope of the present technology and have a surprisingly low viscosity for such concentrated anionic surfactant systems. Note that the viscosity significantly drops in going from 10/s to 32/s indicating these concentrates are shear thinning which will help in their pumpability.

The invention is now described in such full, clear, concise and exact terms as to enable any person skilled in the art to which it pertains, to practice the same. It is to be understood that the foregoing describes preferred embodiments of the invention and that modifications may be made therein without departing from the spirit or scope of the invention as set forth in the appended claims.

What is claimed is:

1. A liquid laundry detergent composition comprising:
a. from 21% to 74% by weight of one or more alkyl ether sulfate amine salts;
b from 2% to 50% by weight of one or more nonionic surfactants;
c. less than 50% by weight water;
wherein the total surfactant present is at least 45% by weight of the composition.

2. The composition of claim 1, wherein the total alkyl ether sulfate amine salt is present in an amount of from 27.5% to 74% by weight.

3. The composition of claim 1, wherein the total alkyl ether sulfate amine salt is present in an amount of from 35% to 74% by weight.

4. The composition of claim 1, wherein the liquid laundry detergent composition is enclosed in a water-soluble pouch.

5. The composition of claim 1 wherein the amine portion of at least one alkyl ether sulfate amine salt is monoethanolamine.

6. The composition of claim 1, wherein at least one alkyl ether amine salt contains an average of from 2.7 to 3.3 moles of ethoxylation and no propoxylation.

7. The composition of claim 1, wherein the liquid laundry detergent composition contains less than 30% by weight water.

8. The composition of claim 1, wherein the liquid laundry detergent composition contains less than 10% by weight water.

9. The composition of claim 1, wherein the liquid laundry detergent composition contains more than 50% by weight total surfactant.

10. The composition of claim 1, wherein the nonionic surfactant is present in an amount of from 10% to 50% by weight.

11. The composition of claim 1, wherein the nonionic surfactant is present in an amount of from 13% to 50% by weight.

12. A concentrated surfactant composition comprising:
a. from 70% to 99% by weight of one or more alkyl ether sulfate amine salts;
b. from 1% to 30% by weight water;
wherein,
the viscosity of the composition at a shear rate of 10/s is less than 25,000 cP at 40° C.; and
the composition contains less than 4% by weight carboxylic acid either in its free acid form, a neutralized form or any combinations thereof.

13. The composition of claim 12, wherein the viscosity of the composition at a shear rate of 10/s is less than 15,000 cP at 40° C.

14. The composition of claim 12, wherein the viscosity of the composition at a shear rate of 10/s is less than 10,000 cP at 40° C.

15. The composition of claim 12, containing from 80% to 99% by weight of one or more alkyl ether sulfate amine salts.

16. The composition of claim 12, containing from 90% to 99% by weight of one or more alkyl ether sulfate amine salts.

17. The composition of claim 12, wherein at least one alkyl ether sulfate amine salt has monoethanolamine as the amine.

18. The composition of claim 12, wherein at least one alkyl ether amine salt contains an average of from 2.7 to 3.3 moles of ethoxylation and no propoxylation.

19. The composition of claim 12, wherein less than 15% by weight nonionic surfactant is present.
